(19) United States
(12) Patent Application Publication
(10) Pub. No.: US 2002/0055298 A1
(43) Pub. Date: May 9, 2002

(54) HOLDER FOR A TEMPERATURE-DEPENDENT SWITCH

(76) Inventors: MICHAEL BECHER, ALTHENGSTETT (DE); EDWIN GUTTINGER, KONIGSBACH (DE)

Correspondence Address: HARNESS DICKEY & PIERCE, P O BOX 828, BLOOMFIELD HILLS, MI, 48303

(21) Appl. No.: 09/021,848

(22) Filed: Feb. 11, 1998

(30) Foreign Application Priority Data
Feb. 13, 1997 (DE) 197 05 411.0

(51) Int. Cl. H01R 4/24

(52) U.S. Cl. 439/459

(57) ABSTRACT

A device (10) for holding a temperature-dependent switch (11) which has two terminals (12, 13) has a holder (17) for receiving the switch (11). Also provided is at least one connector element (22), connected to one of the terminals (12, 13), for external connection, on which an insulation displacement terminal (26) is provided.

### BACKGROUND OF THE INVENTION

1. Field of the Invention

The present invention concerns a device for a temperature-dependent switch which has two terminals, having a holder for holding the switch and at least one connector element, connected internally to one of the terminals, for external connection.

2. Related Prior Art

A holder of this kind is known from DE 90 04 943 U1.

The switch used with the known holder has a housing with a metal lower part that serves as the first terminal for the switch. A second terminal, onto which a lead is soldered, is provided on the cover of the housing. The switch is used to monitor the temperature of a coil, for which purpose it is connected in series with the coil between its external terminals. In the allowable temperature range the switch is closed; it closes only if a maximum allowable temperature is exceeded. The switch can, for example, be a switch such as the one known from DE 21 21 802 A1.

The known holder has a bracket-shaped clamping element made of metal, which holds the switch on the metal lower part and simultaneously makes contact there. The holder furthermore has an insertion tab by means of which it is snap-locked to the coil carrier. Also provided on the holder is a solder lug to which, after snap-locking of the holder, the winding wire of the coil to be protected is soldered.

The lead soldered onto the cover is used for the external terminal, or is soldered in another manner onto the coil carrier.

One of the disadvantages of the known holder is that it is conductive, which raises understandable safety concerns.

A further disadvantage lies in the fact that the winding wire must be soldered onto the solder lug, which is generally accomplished by hand and is thus a definite cost factor in the manufacture of the coil that is to be protected and is equipped with the temperature-dependent switch.

### SUMMARY OF THE INVENTION

In view of the above, it is an object of the present invention to provide a device of the kind mentioned at the outset that can be electrically connected in simple and economical fashion to a device to be protected, and is itself of physically simple design and easy to install.

According to the invention, this object is achieved with the device mentioned at the outset by the fact that an insulation displacement terminal is provided on the connector element for the external connection.

The object underlying the invention is completely achieved in this manner.

Specifically, the inventors of the present application have recognized that, in conjunction with temperature-dependent switches as well, connections using the insulation displacement technique can be made much more quickly and economically than, for example, soldered or clamped connections.

One great advantage of the insulation displacement technique is that the connections can be made in automated fashion, which further reduces costs.

It is preferred in this context if the internal connection between the one terminal and the insulation displacement terminal is made by means of a lead, a further insulation displacement terminal for the lead preferably being provided on the connector element.

The advantage here is that the internal connection is also produced in very simple fashion, so that the switch can easily be mounted on the new holder. Although in this case a switch prefabricated with a lead, which can also be used per se to protect electrical devices, is used in the holder, there nevertheless results a great assembly advantage for the manufacturer of the device to be protected, consisting in the production of the external connection.

But installation of the switch on the new holder is also simple and therefore economical. It is also advantageous that mature series-produced products are used as the switch and can be inserted into the holder; depending on the demands of the device to be protected, a variety of series-produced switches can be inserted into the same holder. The new holder can thus be used as a mass-produced product for various applications, so that it is very economical to produce. Since the respective switches to be inserted into the holder are also mass-produced products, the apparatus assembled from holder and switch is very economical overall, the further advantage of simple assembly also being present for the device manufacturer.

It is preferred in general if a further connector element for external connection, which is connected internally to the second terminal, is provided.

The advantage here is that installation of an apparatus consisting of holder and switch on a device to be protected is further facilitated. The further connector element can, for example, be a customer-specific external terminal, such as a lead, a solder lug, a screw terminal, or also an insulation displacement terminal. The manufacturer of the device to be protected can thus eliminate both the transfer point to the switch and the transfer from the switch to the outside. If an insulation displacement terminal is once again used here, connected via a lead to the second terminal of the switch via a further insulation displacement terminal, there is, so to speak, a doubling of the aforementioned advantages with regard to manufacturing costs.

It is preferred in general if the insulation displacement terminal for the internal connection is configured integrally with the insulation displacement terminal for the external connection, preferably as a plug-in part.

This feature is advantageous in terms of simple assembly, since when the plug-in part is inserted into the holder it is possible, for example, for contact simultaneously to be made between the further insulation displacement terminal and the lead for the internal connection, so that globally only a very few production steps are necessary.

It is particularly preferred in this connection if the holder is an injection molded plastic part, the device for holding the switch preferably being an opening which is adapted to the contour of the switch.

The first advantage of a holder produced from plastic is that it is easy and economical to manufacture, a further advantage consisting in the fact that it electrically insulates the switch and the terminals or insulation displacement terminals from the outside. The holder can thus be attached in any desired way to a device to be protected, for example can be press-fit into a cavity provided thereon. This mechanical attachment can be accomplished in automated fashion, only a few criteria being applicable to the position, since the holder itself is electrically insulated externally.

Advantages also result, however, for installation of the switch on the holder, since the switch simply needs to be pressed into the opening in order to be placed there.

It is further preferred if the new holder has a cavity for the plug-in part and a conduit, joining the cavity and the opening, for the lead.

This feature is also advantageous in terms of easy installation of the switch on the new holder, since when the switch is inserted into the opening, the lead can at the same time be laid into the conduit and from there guided into the cavity, whereupon all that is necessary is to push the plug-in part into the cavity in order to provide for electrical connection between the lead and the plug-in part, i.e. the insulation displacement terminal for the internal connection. These operations can all be automated, thus yielding significant cost advantages.

It is further preferred if two retaining flanges, which extend symmetrically with respect to an insertion opening of the insulation displacement terminal, are arranged parallel to the insulation displacement terminal for the external connection.

This feature is once again advantageous in terms of external contacting, since the retaining flanges not only guide the leads being connected, but also relieve strain on them and protect them from breakage.

Further advantages are evident from the description and the appended drawings.

It is understood that the features mentioned above and those yet to be explained below can be used not only in the respective combinations indicated, but also in other combinations or in isolation, without leaving the scope of the present invention.

### BRIEF DESCRIPTION OF THE DRAWINGS

An embodiment of the invention is depicted in the drawings and will be explained in more detail in the description below. In the drawings:

FIG. 1 shows a plan view of the new switch, the connector element being partly cut away, with the temperature-dependent switch installed; and

FIG. 2 shows a view of the switch of FIG. 1 in the direction of arrow II.

### DETAILED DESCRIPTION OF A PREFERRED EMBODIMENT

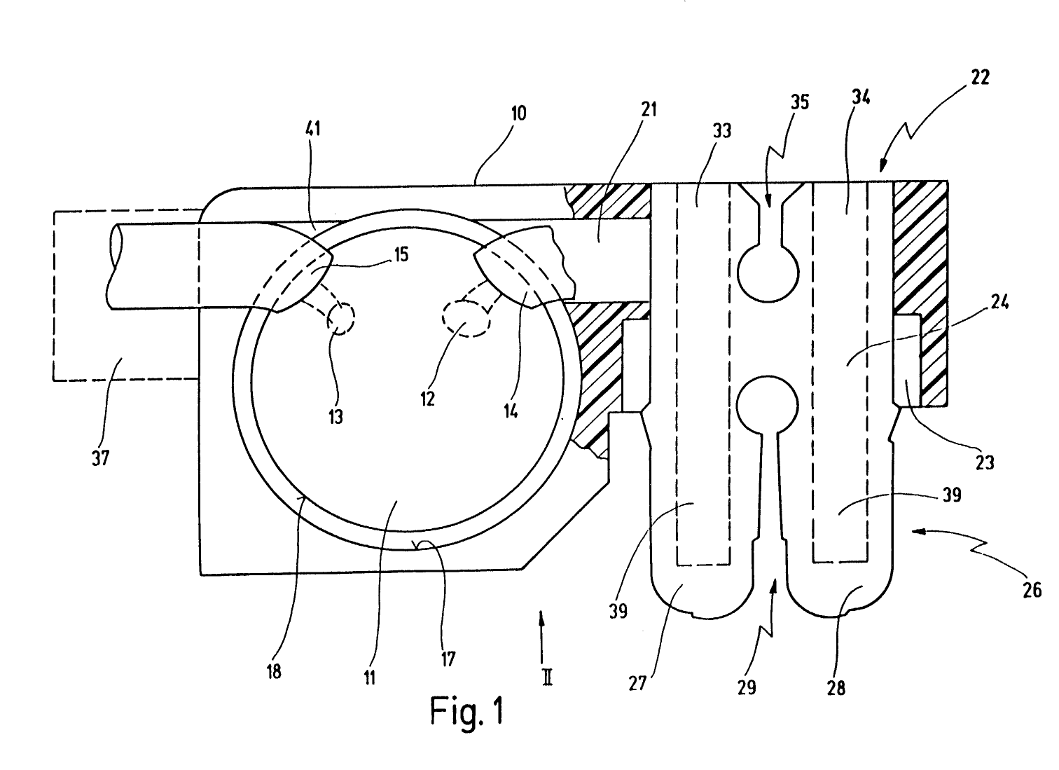

In FIG. 1, 10 designates a holder which is an injection molded plastic part. Arranged on holder 10 is a temperature-dependent switch 11 which has a first terminal 12 and a second terminal 13, which are merely indicated in FIG. 1 because they are located beneath an insulating protective layer. First terminal 12 is connected to a lead 14, while a lead 15 is soldered onto second terminal 13.

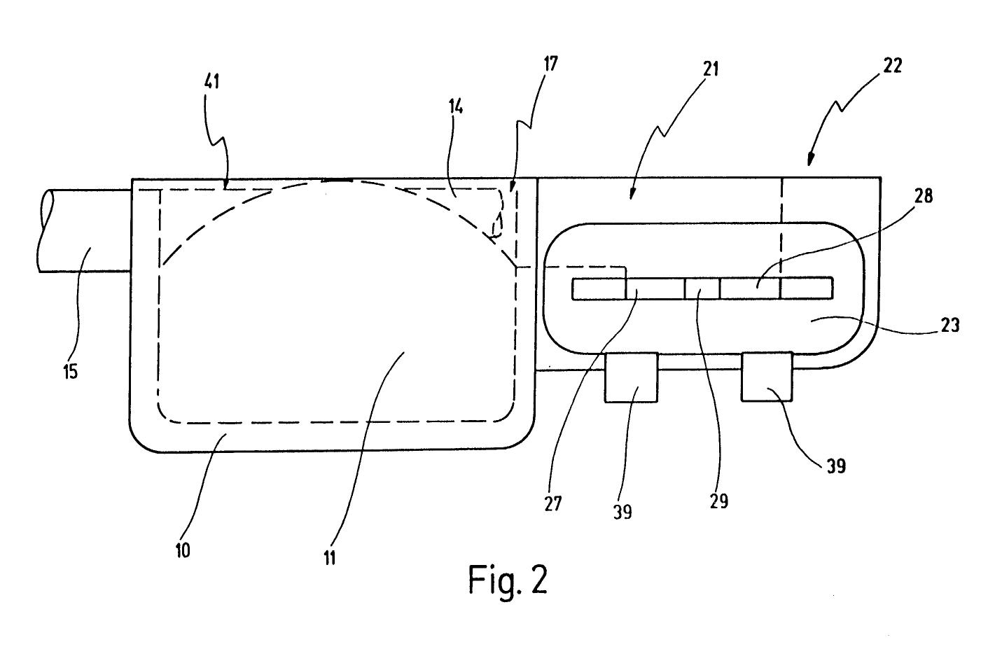

Switch 11 sits in an opening 17, open toward the top, which is adapted to its contour 18. From opening 17, a conduit 21 extends to a connector element 22 for the external connection of switch 11. A cavity 23 into which conduit 21 opens is provided in connector element 22. Conduit 21 is angled for this purpose, as is evident from the view of holder 10 in FIG. 2.

Inserted into cavity 23 is a plug-in part 24 made of metal, on which a first insulation displacement terminal 26 is integrally configured. Insulation displacement terminal 26 comprises two tongues 27 and 28 and an insertion opening 29 defined between them, into which leads for external connection are inserted and secured.

Also configured integrally with inserted part 24 is a second insulation displacement terminal 32 which also has two tongues 33 and 34 and an insertion opening 35 delimited thereby.

Second insulation displacement terminal 32 is used for internal connection to lead 14, which for reasons of clarity is shown only partially in FIG. 1.

Also shown at 37 is a second connector element that is configured identically to connector element 22 but can also comprise a solder lug or a screw terminal, to which lead 15 is respectively connected.

FIG. 2 shows the new holder 1 viewed in the direction of arrow II in FIG. 1. It is first of all evident that switch 11 disappears completely into opening 17, leads 14 and 15 also lying within the outline of holder 10.

Connector element 22 additionally has on its underside two retaining flanges 39, running parallel to one another and to plug-in part 24, which extend symmetrically with respect to insertion opening 29.

The fitting of holder 10 with a temperature-dependent switch 11 is accomplished in such a way that leads 14, 15 are first of all angled to the side so that they fit into conduit 21 or into a corresponding conduit 41 on the opposite side. Switch 11 is then pushed from above into opening 17, as a result of which it is mechanically held therein. In the process, leads 14, 15 pass into conduits 21, 41 and, with corresponding bending, into cavity 23. Plug-in part 24 is then inserted into cavity 23, thus simultaneously making contact with lead 14.

Contact with lead 15 is made as a function of the connection technology selected there; lead 15 itself can also serve as a further external terminal.

These steps for the assembly of holder 10 with a switch 11 are to be performed in automated fashion.

Holder 10 is then inserted, by the manufacturer of an electrical device to be protected by temperature-dependent switch 11, into a cavity provided on the device, and retained there in press-fit fashion. Electrical connection of the device to switch 11 then takes place via insulation displacement terminal 26. Connecting lead 15 or connector element 37 then serves as the first external terminal of the device to be protected.

Therefore, what I claim is:

1. A device for holding a temperature-dependent switch having two terminals, comprising:
a holder for receiving and holding said switch; and
at least one connector element to be connected internally to a first of said terminals, said connector element being provided with a first insulation displacement terminal for external connection.

2. A device as in claim 1, wherein internal connection between said first terminal and the connector element is made by means of a first lead.

3. A device as in claim 2, wherein a second insulation displacement terminal for the first lead is provided on the connector element.

4. A device as in claim 1, wherein a further connector element for external connection, which is connected internally to the second terminal, is provided.

5. A device as in claim 3, wherein the second insulation displacement terminal for the internal connection is configured integrally with the first insulation displacement terminal for the external connection.

6. A device as in claim 5, wherein the first and second insulation displacement terminal are configured as a one-piece plug-in part.

7. A device as in claim 1, wherein it is an injection. molded plastic part.

8. A device as in claim 1, wherein the holder for holding the switch has an opening which is adapted to a contour of the switch.

9. A device as in claim 6, wherein it has a cavity for the plug-in part and a conduit, joining the cavity and the opening, for the lead.

10. A device as in claim 1, wherein two retaining flanges are provided, which extend symmetrically with respect to an insertion opening of the first insulation displacement terminal, and are arranged parallel to the first insulation displacement terminal for the external connection.
